(19) United States
(12) Patent Application Publication
(10) Pub. No.: US 2004/0117249 A1
(43) Pub. Date: Jun. 17, 2004

(54) Business improvement program with on-line access

(76) Inventors: Annie X. Wang, Houston, TX (US); Stephen L. Cox, Houston, TX (US); Stephen E. Houston, Montgomery, TX (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/320,223

(22) Filed: Dec. 16, 2002

(51) Int. Cl. G06F 17/60

(52) U.S. Cl. 705/14

(57) ABSTRACT

A fully integrated customer loyalty and business enhancement program for non-retail, i.e., corporate, customers is disclosed. A user may access the program on-line and may browse a product catalog for shopping. The user may electronically place an order, upon which the program automatically checks the user's credentials and electronically issues a purchase order to the supplying company. The program also calculates loyalty points based on each purchase, updates the award account of enrolled users, and communicates that number of awarded points to the user. Enrolled users may browse through a business award catalog, which includes value added business services and business tools that have the ability to enhance the user's business, and electronically redeem an amount of awarded points towards an award. The program preferably then electronically places an award redeeming order with the fulfillment house and updates the user's loyalty account.

### FIELD OF THE INVENTION

The present invention relates to combination of customer incentive and business improvement program and in particular to an interactive on-line customer incentive business improvement program which can be used by various industries that sell to non-retail customers to cultivate customer loyalty. The program of this invention is designed to improve the performance of businesses, more particularly to a program that focuses on continuous business improvement and that utilizes the worldwide web for access.

### BACKGROUND OF THE INVENTION

Customer retention has become a pressing issue in many industries that sell to non-retail or corporate customers, particularly in the powder coatings industry. The powder coating market is becoming highly saturated and powder coating manufacturers continue to lose powder customers due to pricing battles rather than product differentiation.

Typical powder customers are also facing many challenges, such as: market saturation, excess capacity, margin erosion and reduction on US manufacturing sector. More and more powder users are therefore seeking further differentiation from competitors. Business improvement and cost saving have become more important than ever.

To improve the business efficiency and profitability, most small businesses need extensive, readily available data on how business is currently performing against business forecast as well as how well or poorly the business is performing against similarly situated business in the industry. However, many businesses, especially small businesses, having only a handful of employees, may not able to afford to hire additional employees or consultants that are typically needed to conduct in-depth business analysis and find out cost saving strategies.

Currently, there is not an established organization for business owners in powder coating industry. It is cumbersome, expensive and time consuming for small business owners to collect information or find a reliable source to conduct such services

Thus, a need exists for a less cumbersome business improvement process for powder coating customers and a customer loyalty process for powder coating manufactures.

Many retail, as opposed to non-retail, industries, most notably the airline industry, have previously developed frequent shopper or incentive programs in the past to promote customer loyalty. An example of such a program is a “frequent flyer” program. According to such a program, when a traveler books a flight, a certain amount of “mileage points” are calculated by a formula using the distance of the destination as a parameter. After the traveler has taken the flight, the mileage points are awarded. When a traveler has accumulated a sufficient number of mileage points, he may redeem these points for an award chosen from a specific list of awards specified by the program, such as a free flight or free rental car.

Retail frequent shopper program also will typically segment customers into two or more groups depending on how much money the shoppers spend. For high frequency customers, the program can reward the frequent shopper other benefits such as applying a higher percentage of points. The size of the award or other benefit is usually computed as a function of the group to which the shopper belongs. Naturally, the best shoppers receive the highest point percentage or benefits.

A major challenge that faces many industries that sell to non-retail customers is how to attract and maintain corporate customers with a frequent shopper or loyalty program that offers more than just gifts or discounts for awards. Since corporate customers typically do not base purchasing decisions on instant rewards and promotional gimmicks, what is needed is a loyalty program that makes a long term investment in the future success of the customer's business.

Accordingly, there is also a great need for a customer loyalty program that can offer value added business services and business tools to its corporate customers, that can assist the customers in managing their business.

The novel customer loyalty and business improvement program, which preferably utilizes the worldwide web, has the aforementioned desirable characteristics.

### SUMMARY OF THE INVENTION

The program of this invention is designed to enhance small business, particularly custom coater's performance in the powder coatings industry, through training seminars, customized consulting services and business improvement related services and business tools which will in turn cultivate customer loyalty, leverage manufacture brand equity and grow its market share. The integrated business enhancement program will provide members with options that enable them to check points and chose business improvement services and business tools via network or personal contacts.

A customer incentive business improvement program is therefore provided for non-retail customers, including a computer system accessible for on-line interactive communication with customers, the computer system comprising:

a first memory area or database for storing an awards catalog, said awards catalog including descriptions of business improvement award services and business tools offered by the program and award point values for each award service and business tool;

a frequency database storing account information and award points for each enrolled user of said incentive award program;

a purchase history database for storing purchase history information for each enrolled user; and

means for updating said frequency database with information based on customer's shopping history that is stored in the purchase history database,

wherein the award services and business tools offered by the program are selected from the group consisting of technical training, business training, safety training, purchasing programs, networking meetings, study tours, marketing support, business improvement support, legal support, business benchmarking, customized consulting and co-branding programs that will allow the customer to use the brand equity of the supplier.

The present invention is preferably enabled by network-based business process comprising the steps of:

1. Receiving request an initial request from a customer computer linked with host computer through a network;

2. Completing a log-on procedure to allow the customer computer to access a main menu comprising one or more business tools and services suitable for business improvement;

3. Requesting the customer to choose a business tool or service from the main menu;

4. Processing the chosen business tools or services;

5. Providing a business solution or service either via world wide web or personal visits

The business tools and business service awards in the main menu are selected, without limitation, from the group consisting of:

1. Business training

i. Productivity

ii. Financial analysis

iii. Estimating

iv. Firing and hiring

v. Safety

vi. Sales and production tracking

vii. Supply chain management

2. Benchmarking

3. Customized consulting

i. Productivity

ii. Plant layout

iii. ISO certification

iv. Process audits

v. Marketing solutions

vi. Efficiency

vii. Safety

viii. Legal

4. Nationwide network—which allows customer's to communicate with other customers about business improvement programs

5. Business Certification programs—leverage the manufacture's brand equity to help business gain instant recognition, improve overall business standard

6. Leveraged Purchasing Solutions—leverage the manufactures buying power to improve cost savings

7. Information exchange tools

8. Any other services related to business improvement, and

9. Combinations thereof.

### BRIEF DESCRIPTION OF THE DRAWINGS

The foregoing summary, as well as the following detailed description of the preferred embodiments, will be better understood when read in conjunction with the appended drawings. In the drawings:

FIG. 1 is a flow diagram showing the inventive arrangements of the frequent buyer program according to the present invention;

FIG. 2 is a flow diagram showing the access part of the program of the preferred embodiment of the present invention; and

FIG. 3 is a flow diagram showing an exemplary routine for operating the frequent buyer program.

### DETAILED DESCRIPTION OF THE INVENTION

As defined herein:

“Host” is the one who markets and offers the business enhancement and customer loyalty process of the present invention to one or more customers located worldwide;

“Customer” is the one who utilizes the business enhancement process of the present invention offered by the host. One example of a customer is a custom coater, which provides powder-coating services;

“Host computer” is a host-operated computer programmed with software to perform the business enhancement process of the present invention, the host computer can include one or more computers coupled to act as a host computer and the host computer can be located within the US or outside of US;

“Customer Computer” is a customer-operated computer located at a customer's place of business that is programmed to communicate with the host computer. The customer computer can be located within the US or outside of US.

The value added program of the present invention is designed to cultivate customer loyalty as well as to help small business owners to grow their business. By providing business tools and services that enable small business owners to grow their business, this in turn will enhance customer loyalty and leads to increased purchases from service providers.

Under the program of the present invention, when a customer makes an order, a certain amount of “loyalty points” are calculated by a formula that is predetermined. After the purchase is done, the loyalty points are awarded. When a customer has accumulated a sufficient number of loyalty points, he/she may redeem the points for any business improvement related expenditures. The award can be chosen a wide range of items from the menu that manufacture provided or an outside the list.

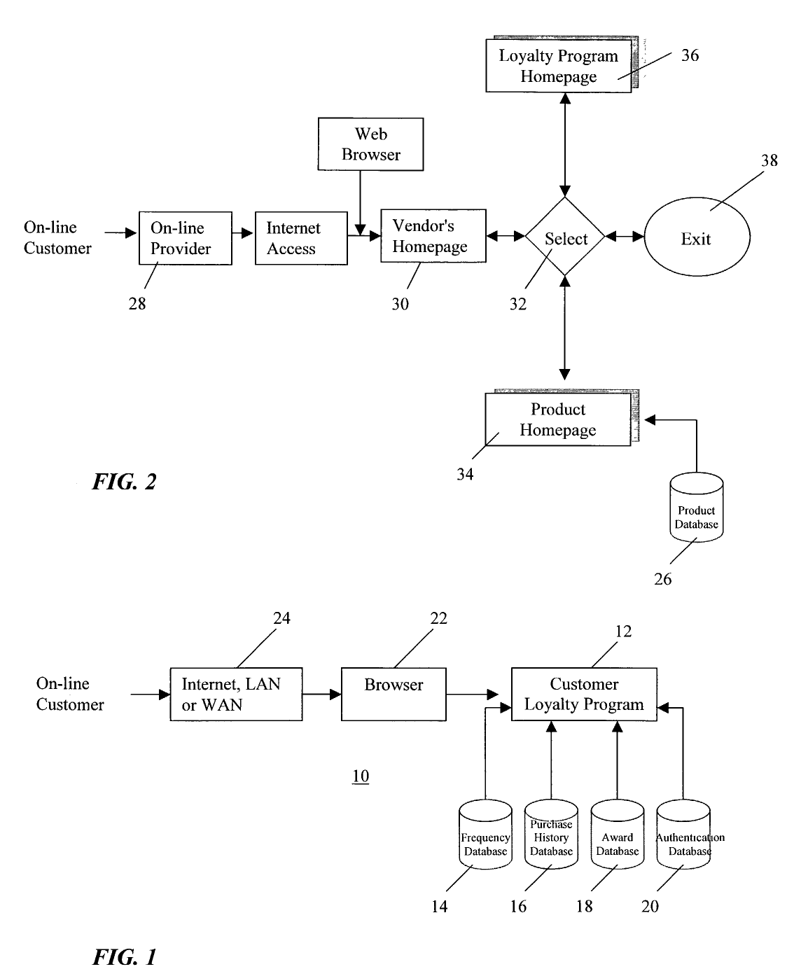

The program according to the present invention will now be described with reference to FIGS. 1-3. FIG. 1 shows a block diagram of a data supported website 10 that comprises an interactive system of the kind that supports, at a minimum, a frequent buyer or customer loyalty program 12 for non-retail customers, especially small corporate customers.

The system preferably contains at least two sets of information—a frequency database 14 and a purchase history database 16—that interact with each other to implement the non-retail customer loyalty program. The system may also, and preferably does, contain an award database 18 for listing the award business services and business and redemptions and an authentication database 20 for security purposes.

The system, at a minimum, thereby provides a loyalty program that has the ability to communicate between databases and track purchases based on a particular loyalty customer's purchase history, calculate bonus or loyalty points based on each purchase, and keep a running tally of available points. Preferably, it also allows the frequent purchasers to redeem points for business tools and services based on the number of bonus points in the customer's loyalty account.

Basic information about the loyalty customers will be kept in the frequency database 14. This database can contain, without limitation: a frequent buyer identification code, demographic information such as name, address, industry, business size, and recent award requests.

The second database 16 of historical purchase data is then preferably indexed by loyalty customer and should minimally contain, on a per loyalty customer basis, the list of items purchased during each shopping experience, whether the purchase was made on-line or off-line by traditional methods. For each item on a given list, the following information should be provided, the product code, quantity, and purchase price.

These two databases 14 and 16 are programmed to interact, so that loyalty program after each purchase or through periodic and scheduled updates, will obtain the relevant prior purchases from the purchase history database 16 and proceed to calculate the award points according to a preprogrammed formula, such as based on the amount of pounds of powder coatings purchased, and thereafter add the points to the loyalty customer's account which is maintained in the frequency database and, on demand, display the account information and the added points to the user.

The business tools and services award database 18 also should contain a list of the tools and services and the amount of points needed to purchase each tool or service. Since the customer loyalty program of this invention is designed for non-retail, i.e., corporate customers, the list of awards will include value added business services and business tools needed to run a successful business. This loyalty program is especially useful for small corporate customers that may not have the business skills, education and tools needed to run a successful business.

Accordingly, the business tools and services are preferably selected in any of those listed above, including, for example the following: technical training program, business training, safety training, quality training, process training, leveraged purchasing solutions, marketing support, business improvement support, legal services, and co-branding programs that will allow the customer to capitalize on the brand equity of the supplier. Oftentimes, the product supplier or vendor is more sophisticated than the purchaser and understands the purchaser's markets and business better than the purchaser. Therefore, the product supplier, with the services offered, can assist the purchaser in running his business more efficiently and more cost effectively.

It will be appreciated by those skilled in the art that the loyalty points can be used for any business improvement related purchases, and there is no limits on how to spend the loyalty points (preferably with the exception of a program membership fee and powder expenses). Customers can spend it on items that will help their business, such as equipment, attending tradeshow, design a website etc.

In another embodiment, however, the list of awards might also include some traditional benefits such as applying a discount to the purchase price.

In order for the customer to redeem a particular award, the number of points required to redeem that particular qualifying award can be retrieved from the business tools and services database. Similarly, the user's frequency account is accessed and the number of points in the user account is retrieved and supplied to the database. The number of points read from the user's account is then subtracted from the number of points read from the information and the number of points in the user's account located in the frequency database is updated.

The system can be implemented as a stand alone computer server or as a local area network (LAN) or as a wide area network (WAN). The databases 14, 16, 18, and 20 can reside in the same computer as the server (which can be the host computer) or in one or more separate computers (which can be the customer computers) on a LAN or WAN, or even be connected over the Internet.

Corporate customers can access from the customer computer the data supported website 10 through a web browser 22 and the Internet, a WAN and/or a LAN, represented collectively by 24, to check the loyalty program and the available points in their individual accounts, as shown in FIG. 1.

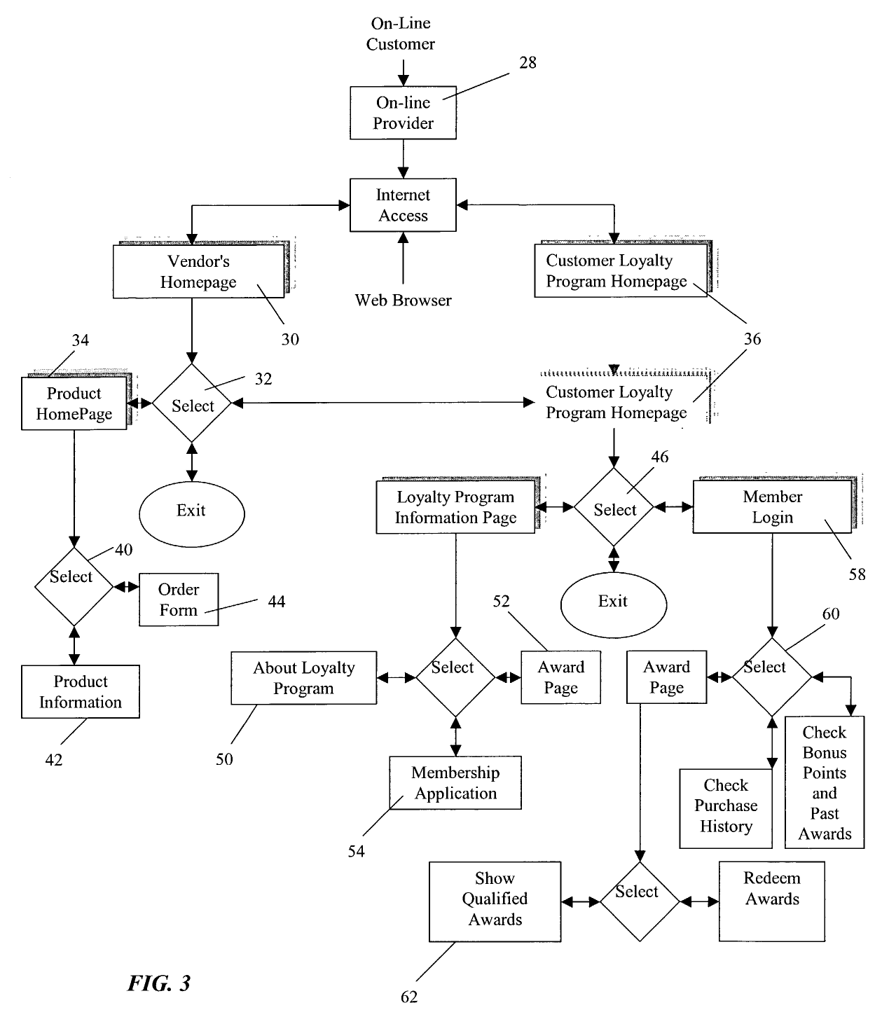

Optionally, the system can include a product database 26 (shown in FIG. 2) that allows customers, at a minimum, to view the supplier's offerings and may also allow the customer to purchase products on-line.

In the preferred embodiment as shown in FIG. 2, upon gaining Internet access, for example, via an on-line provider such as AOL™ 28, to the data supported website that contains the customer loyalty program 12, such as the Vendor's Homepage 30, the program proceeds to a selection menu or main menu 32. (It will be understood by those skilled in the art that Vendor's Homepage 30 is the main Internet address for the vendor.) Depending on the user's choice, from the selection menu 32 the program may proceed to the Vendor's Product Homepage 34 or the Customer Loyalty Program Homepage 36. Alternatively the user may choose to exit the program via Exit 38.

It should be also noted from the outset that in the preferred embodiment of the disclosed invention, the user may back-track from any particular point in the program. This being stated generally, it will be appreciated that this feature is applicable to the further program steps of the preferred embodiment described below and, therefore, it will not be repeated in the following description.

In FIG. 2, the Product Homepage 34, which is preferably included in the present invention, is a homepage that identifies a particular brand of products. For example, the Product Homepage may be a homepage for a particular brand of powder coatings, such as Du Pont® brand powder coatings. In such an example, Product Homepage 34, may include icons to allow the user to select information regarding, for example, different products offered, product types (epoxy, polyester, wrinkle, glossy, etc.), and price ranges, and thereafter review information regarding the selected products sold by this particular brand, in a manner similar to reviewing a printed catalog.

In the preferred embodiment, the capability to view information regarding the various products is enhanced by providing the user with a searching tool, generally implemented in the form of icons. Thus, for example, the user may choose to list the products alphabetically, list the vendor's brands alphabetically, or use a search engine to create a group of products which fit the user's requirements. Any conventional search engine may be used for this purpose. Such a search engine can be implemented for accepting a boolean string, or by collecting the user's response to an inquiry set. The fields for the search engine may include, for example, key words, brands, price range, material etc.

In FIG. 2, the Product Homepage, 34, is depicted as multiple pages. This depiction signifies that the Product Homepage may include more than one page. Thus, if a large amount of information needs to be included in Product Homepage, the home page may actually comprise several pages and the user will be provided with a scroll option so as to be able to scroll over the information pages.

In a similar manner, the Customer Loyalty Program Homepage 36, is shown in the Figures as multiple pages. (It will be understood by those skilled in the art that Loyalty Program Homepage 36 is the main Internet address for the incentive program system). This depiction also signifies two features of the program of the present invention. The first feature, is that Program Homepage, 36, may comprise multiple pages with a scrolling feature to allow the user to scroll for viewing the information contained in the pages. The second feature is that several incentive level programs may be and preferably are available for access from the selection menu 32.

In the case of several incentive level programs, restrictions may be imposed for accessibility to the various incentive level programs. For example, the incentive company may manage programs differently at each level. The first level incentive program can be accessible for enrollment by all approved users. On the other hand, the incentive company may allow limited access to the higher-level incentive programs for providing information only, while enrollment may be restricted only to those users who satisfy set requirements. These requirements may relate, for example, to a certain level of purchasing within a given period, credit rating, exclusivity etc. As in the above, while these various features have been described herein, they are depicted in the drawing simply by showing multiple pages following the Loyalty Program Homepage 36. The supplier will determine membership level requirements.

The Loyalty Program Homepage 36, also preferably contains a configurable authentication and security feature, such as a login screen (not shown in FIG. 2), which requests the user's frequent buyer identification code and preferably a password before gaining access to the user's loyalty account.

Referring now to FIG. 3. In the preferred routine for operating the customer loyalty program according to the invention (e.g., from selection menu 32), if a user selects the Product Homepage 34, the program proceeds to a selection menu 40, which provides the user with the following options: proceed to Product Information Page 42 or proceed to Order Form 44.

If a user selects the Customer Loyalty Program Homepage 36 (e.g., from selection menu 32), the program proceeds to another selection menu or main menu for the loyalty program 46 which provides the user with the following options: proceed to Loyalty Program Information Page 48 and its associated selection menu which allows users to view information about the loyalty program 50, view program award information 52, or allow non-members to enroll in the loyalty program using an on-line membership application 54 susceptible to electronic entries. If a loyalty program membership application is made, the application is submitted by electronic means such as e-mail or facsimile so as to render the program of the present invention fully integrated in an interactive on-line system; however, the membership application form can alternatively be placed by conventional means by simply printing and mailing the form to the product company or calling in the requested customer information. This will allow the customer upon acceptance of the application to enjoy the benefits of the loyalty program, which will be described later. From this point, the program may return to the Product Homepage 34, to the Loyalty Program Homepage 36 or proceed to the Selection Menu 32.

Upon selection of the Product Homepage 32, the program allows the customer to review the available products, business tools and services offered by the company. The program can also allow the customer to purchase products using an on-line order form susceptible to electronic entries. If a purchase is made, the program preferably proceeds to establish a communication link and places a product order, with the product company. In the preferred embodiment, the product order is placed by electronic means such as e-mail or facsimile so as to render the program of the present invention fully integrated in an interactive on-line system; however, the order form can alternatively be placed by conventional means by simply printing and mailing the order form to the product company or calling in the order.

Once a purchase is made, while the communication link is established to the product company, the program can also proceed to the frequency database 14. In the frequency database, the user's information is checked against the database of enrolled users. If it is determined that the user is an enrolled user, the program proceeds to calculate the award points according to a preprogrammed formula. Thereafter the program proceeds to add the points to the enrolled user's account, and display the account information and the added points to the user. From this point, the program may return to the Product Homepage 34, to the Loyalty Program Homepage 36 to view the awards catalog or proceed to the Selection Menu 32.

The preferred embodiment includes a particular feature wherein in addition to displaying the points added to the account, the program includes a routine to display a list of awards available from the awards database, preferably based on the particular's user qualification level, and the number of points required to redeem the particular award that the user is qualified to receive. Once the user chooses an award, the number of points required to redeem the particular qualifying award is then retrieved from the business award database and the user's account in the frequency database is then accessed and the number of points in the user account is retrieved. The number of points read from the user's account is then subtracted from the number of points read from the award information and the user's frequency account is updated and the result is displayed

On the other hand, if it is determined that the user is a new, unenrolled user, the program can send a message to the user identifying how many points he will earn should he enroll in the program and the program benefits and can inquire whether the user is interested in joining the program.

If it is determined that the user would like to sign up with the award program (join), the program proceeds to a sign up routine 54. Any conventional sign up routine may be used at this stage of processing. At the end of the sign up routine, the program can return to the any of the Home Pages or selection menu. The user may sign off from any of these locations. The enrollment routine may be entered from many different places in the program, e.g., after making a purchase, after reviewing information regarding the program, etc. Once a new enrollment is made, a new user account will be established in the purchase history database and the frequency database and the program will return to the Product Home Page, Loyalty Program Homepage, or Selection Menu.

When a user selects the Loyalty Program Homepage 36 (e.g., from the selection menu 30), at the outset, the program proceeds to preferably to selection menu 46 in FIG. 3.

Still referring to FIG. 3, the selection menu 46 allows the user to exit the program, go to the Member Login Screen 58, learn about the award program by selecting About Award Program 50, apply for membership by selecting Membership Application 54, review the user's account by selecting the Frequency Database 14 linked to the Member Login screen 54, or review the awards catalog by selecting Award Catalog Database 18.

Upon selecting the Login screen 58, which is linked to the Frequency Database 14, the user will be prompted to enter the account number, the identification code, or both at step 58 for security and authentication purposes. In the program of the present invention, the account number and the identification code are linked together, for user for which they are available. Thus, when a user account is established in the frequency database, data is included to link the user's account number to the user's identification code.

For security purposes, it is preferable that the program will not proceed to selection step 60 to display the account information before the user has been prompted and has entered at least the correct identification code at step 58, which is matched with the account number. The user's account information is then displayed.

In the preferred embodiment, the account information for each enrolled user includes a plurality of registers each for indicating an enrollment level for each of said enrolled users, such as diamond, platinum, and gold membership based on a preprogrammed formula. The enrollment level for each user will also be displayed and the user will have access to the award database wherein the award catalog includes enrollment level required for redemption of each award service and wherein access for obtaining an award service is restricted to users qualified for that enrolment level.

The qualified business awards will then be displayed to the user in step 62 from the awards database and the amount of points required to receive each award will be displayed. Among the services offered will be training programs (e.g., technical, management), improvement programs (e.g., marketing improvement, finance improvement), purchasing programs that will allow the customer to obtain, for e.g., equipment and insurance, using the product company's negotiated discounted rates, enable the customer to enter into a certification program whereupon the certified customer is able to take advantage of co-branding opportunities with the product company and take advantage of the product company's brand equity, and enable the certified customers to network with other customers and participate in scheduled business roundtable discussions and visitations to other certified customer plants. All of these programs may be, and preferably are, web-enabled and therefore available over the Internet, WAN or LAN.

If the user selects a qualified award from the award database, processing proceeds to the routine described above and the user's account in the frequency database is updated.

To implement the above-mentioned feature, the program accesses the user's account in the frequency database and reads the amount of award points the user has in his account. Then, whenever the user selects an award, the program subtracts the proper number of points required to redeem the award from the user's account and an adjustment is made in the frequency database. A communication link is then established to the product manufacturer and an award order is communicated. The award order is preferably placed on an award redemption form susceptible to electronic entries. In the preferred embodiment, the award order is placed by electronic means such as e-mail or facsimile so as to render the program of the present invention fully integrated in an interactive on-line system; however, the order form can alternatively be placed by conventional means by simply printing and mailing the order form to the product company or calling in the order. Thereafter, the program returns to the Program Homepage.

The program also preferably includes a feature that allows the product company or program administrator to update the user accounts in the frequency and purchase history databases and adjust the award database. These particular users may be provided with a special access code. Upon entering the special code, these particular users may be provided with a privileged access to the program, which allows them to make limited changes to the data. Thus, for example, a merchant may use this special access to change a price charged for a particular product. Similarly, a program administrator may gain privileged access to enter newly added awards available through the program.

Various modifications, alterations, additions or substitutions of this invention will be apparent to those skilled in the art without departing from its spirit and scope. Accordingly, this invention is not limited by the illustrative embodiments set forth herein, but rather is defined by the following claims.

1. A customer incentive and business improvement program for non-retail customers, including a computer system accessible for on-line interactive communication with customers, said computer system comprising:
a first memory area or database for storing an awards catalog, said awards catalog including descriptions of the awards offered by the program and award point values for each award;
a frequency database storing account information and award points for each enrolled user of said incentive award program;
a purchase history database for storing purchase history information for each enrolled user; and
means for updating said frequency database with information based on customer's shopping history that is stored in the purchase history database,
wherein the awards offered by the program are selected from the group consisting of award business services and business tools.

2. The customer incentive program of claim 1 wherein the award business services and business tools offered by the program are selected from the group consisting of business training, benchmarking, customized consulting, nationwide networking, certification program, co-branding program, purchasing solutions, information exchange tools, any other services related to business improvement, and combinations thereof.

3. The customer incentive program of claim 2 wherein the award business services and business tools include at least one of the following items:
(a) Business training selected from the following training programs
i. Productivity
ii. Financial analysis
iii. Estimating
iv. Firing and hiring
v. Safety
vi. Sales and production tracking
vii. Supply chain management
(b) Benchmarking
(c) Customized consulting selected from the following consulting services.
i. Productivity
ii. Plant layout
iii. ISO certification
iv. Process audits
v. Marketing solutions
vi. Efficiency
vii. Safety
viii. Legal
(d) Nationwide networking
(e) Business Certification programs which use the brand equity of the supplier
(f) Leveraged Purchasing Solutions—leverage the manufactures buying power to improve cost savings;
(g) Information exchange tools and
(h) Any other services related to business improvement
(i) Combinations thereof

4. The customer incentive program of claim 2 wherein the award business services and business tools include at least one of the following items: technical training, business training, safety training, process training, leveraged purchasing solutions, marketing support, business improvement support, networking solutions, legal support, certification and co-branding programs that will allow the customer to use the brand name of the supplier.

5. The customer incentive program of claim 1, which further comprises:
a second memory area or database for storing a product catalog, said product catalog including product descriptions and product prices for each product available to purchase.

6. The customer incentive program of claim 1, wherein the updating step takes place on at least one of:
a demand from said customer loyalty system;
a scheduled basis; and,
automatically after said purchase history database changes.

7. The customer incentive program of claim 1, wherein said account information for each enrolled user comprises a plurality of registers each for indicating an enrollment level for each of said enrolled users.

8. The customer incentive program of claim 7, wherein said award catalog includes enrollment level required for redemption of each award service and wherein access for obtaining an award service is restricted to users qualified for said enrolment level.

9. The customer incentive program of claim 1 wherein said computer system further includes an authentication database that requires an access code before each user can view its frequency and purchase history data.

10. The customer incentive program of claim 1 that is enabled by network-based business process comprising the steps of:
(a) receiving request an initial request from a customer computer linked with host computer through a network;
(b) completing a log-on procedure to allow the customer computer to access a main menu comprising one or more business tools and services suitable for business improvement;
(c) requesting the customer to choose a business tool or service from the main menu;
(d) processing the chosen business tools or services;
(e) providing a business solution or service either via world wide web or personal visits.

11. The customer incentive program of claim 1 that is used in the powder coatings industry.

12. A customer incentive and business improvement program for non-retail customers, including a computer system accessible for on-line interactive communication with customers, said computer system comprising:
a first memory area for storing a product catalog, said product catalog including product descriptions and product prices for each product available to purchase,
a second memory area for storing an awards catalog, said awards catalog including descriptions of award services and business tools offered by the program and award point values for each award;
a frequency database storing account information and award points for each enrolled user of said incentive award program;
a purchase history database for storing purchase history information for each enrolled user; and
means for updating said frequency database with information based on customer's on-line and off-line shopping history that is stored in the purchase history database,
wherein the award services and business tools offered by the program are selected from the group consisting of technical training, business training, safety training, process training purchasing programs, marketing support, business improvement support, legal support, and co-branding programs that will allow the customer to use the brand name of the supplier.

13. The customer incentive program of claim 12, wherein said computer system is programmed to perform the steps comprising:
providing a user with on-line access to a product homepage and an award program home page, said product home page linking to said first memory area, and an award program homepage linking to said second memory area;
providing said user with an on-line order form for ordering a product for purchase, said order form being susceptible to electronic entries; and,
providing said user with an on-line redeeming form for redeeming accumulated award points towards an award service chosen from said awards catalog, said redeeming form being susceptible to electronic entries.

14. The customer incentive program of claim 12, wherein said account information for each enrolled users comprises a plurality of registers each for indicating an enrollment level for each of said enrolled users.

15. The customer incentive program of claim 14, wherein said award catalog includes enrollment level required for redemption of each award service and wherein access for obtaining an award service is restricted to users qualified for said enrolment level.

16. The customer incentive program of claim 12 wherein said computer system further includes an authentication database that requires an access code before each user can view its frequency and purchase history data.

17. A computer readable substrate having a computer program saved thereon, said computer program capable of providing a user with on-line access to a customer incentive program having a frequency database and a purchase history database and an awards catalog associated therewith, whereby each user can access their loyalty account to review bonus points and redeem awards, whereby the awards offered by the program consist essentially of business services and business tools that can be used to enhance the customer's business.
